(19) United States
(12) Patent Application Publication
(10) Pub. No.: US 2021/0324921 A1
(43) Pub. Date: Oct. 21, 2021

(54) CLUTCH DEVICE

(71) Applicant: JTEKT CORPORATION, Osaka-shi (JP)

(72) Inventors: Ryouichi KUBO, Kashihara-shi (JP); Takahiro KUBO, Takahama-shi (JP); Shun ONO, Anjo-shi (JP)

(73) Assignee: JTEKT CORPORATION, Osaka-shi (JP)

(21) Appl. No.: 17/228,886

(22) Filed: Apr. 13, 2021

(30) Foreign Application Priority Data
Apr. 15, 2020 (JP) 2020-072748

(51) Int. Cl. F16D 48/02; F16D 13/52; B60K 17/02

(52) U.S. Cl. CPC F16D 25/14; B60K 17/02; F16D 13/52

(57) ABSTRACT

A clutch device includes a plurality of clutches; a plurality of cylinder chambers provided to respectively correspond to the clutches; a pump configured to discharge a hydraulic fluid; a plurality of control valves each of which is configured to control the hydraulic fluid supplied from the pump to a corresponding one of the cylinder chambers; and an oil passage that distributes the hydraulic fluid discharged from the pump, to the control valves. The oil passage includes at least one split point at which the hydraulic fluid discharged from the pump splits. At least one check valve is provided between the at least one split point and at least one control valve among the control valves, the at least one check valve being configured to block a flow of the hydraulic fluid in a direction from the at least one control valve toward the at least one split point.

### CROSS-REFERENCE TO RELATED APPLICATION

This application claims priority to Japanese Patent Application No. 2020-072748 filed on Apr. 15, 2020, incorporated herein by reference in its entirety.

### BACKGROUND

### 1. Technical Field

The disclosure relates to a clutch device including a plurality of clutches.

### 2. Description of Related Art

Examples of clutch devices that can vary the distribution ratio of driving force between right and left wheels of a vehicle include those described in Japanese Patent Application Publication No. 2018-128051 (JP 2018-128051 A) and Published Japanese Translation of PCT Application No. 2019-519734 (JP-2019-519734 A). Each of the clutch devices described in JP 2018-128051 A and JP-2019-519734 A includes a pair of multi-disc clutches; a plurality of pistons and a plurality of cylinders provided so as to correspond to a pair of the multi-disc clutches; a pump that discharges a hydraulic fluid; and a plurality of control valves that controls the hydraulic fluid supplied from the pump to the cylinders. A vehicle provided with such a clutch device can travel stably with less understeer, for example, by distributing a larger driving force to the left wheel than to the right wheel when turning right and distributing a larger driving force to the right wheel than to the left wheel when turning left.

### SUMMARY

In the clutch devices as described above, for example, when one of the multi-disc clutches is first pressed and, in this state, the other multi-disc clutch is pressed, the driving force (torque) transmitted by the one multi-disc clutch may vary temporarily. The present inventors have found the problem, and worked vigorously on a solution and eventually developed the disclosure.

The disclosure provides a clutch device that can stabilize torque transmitted by a plurality of clutches that operates due to hydraulic pressure.

One aspect of the disclosure relates to a clutch device. The clutch device includes a plurality of clutches; a plurality of cylinder chambers provided such that the cylinder chambers respectively correspond to the clutches; a pump configured to discharge a hydraulic fluid; a plurality of control valves each of which is configured to control the hydraulic fluid supplied from the pump to a corresponding one of the cylinder chambers; and an oil passage that distributes the hydraulic fluid discharged from the pump, to the control valves. The oil passage includes at least one split point at which the hydraulic fluid discharged from the pump splits. At least one check valve is provided between the at least one split point and at least one control valve among the control valves, the at least one check valve being configured to block a flow of the hydraulic fluid in a direction from the at least one control valve toward the at least one split point.

The clutch device according to this aspect of the disclosure can stabilize torque transmitted by the clutches.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram schematically showing an example of the configuration of a four-wheel-drive vehicle provided with a clutch device according to a first embodiment of the disclosure;

FIG. 2 is an overall sectional view showing an example of the configuration of a driving force distribution device;

FIG. 3 is an enlarged view showing a part of FIG. 2 in an enlarged manner;

FIG. 4 is a view showing a part of FIG. 2 in a further enlarged manner;

FIG. 5 is a configuration diagram showing an example of the configuration of a hydraulic unit;

FIG. 6 is a configuration diagram schematically showing an example of the configuration of a four-wheel-drive vehicle provided with a clutch device according to a second embodiment; and

FIG. 7 is a configuration diagram showing an example of the configuration of a hydraulic unit according to the second embodiment.

### DETAILED DESCRIPTION OF EMBODIMENTS

First Embodiment

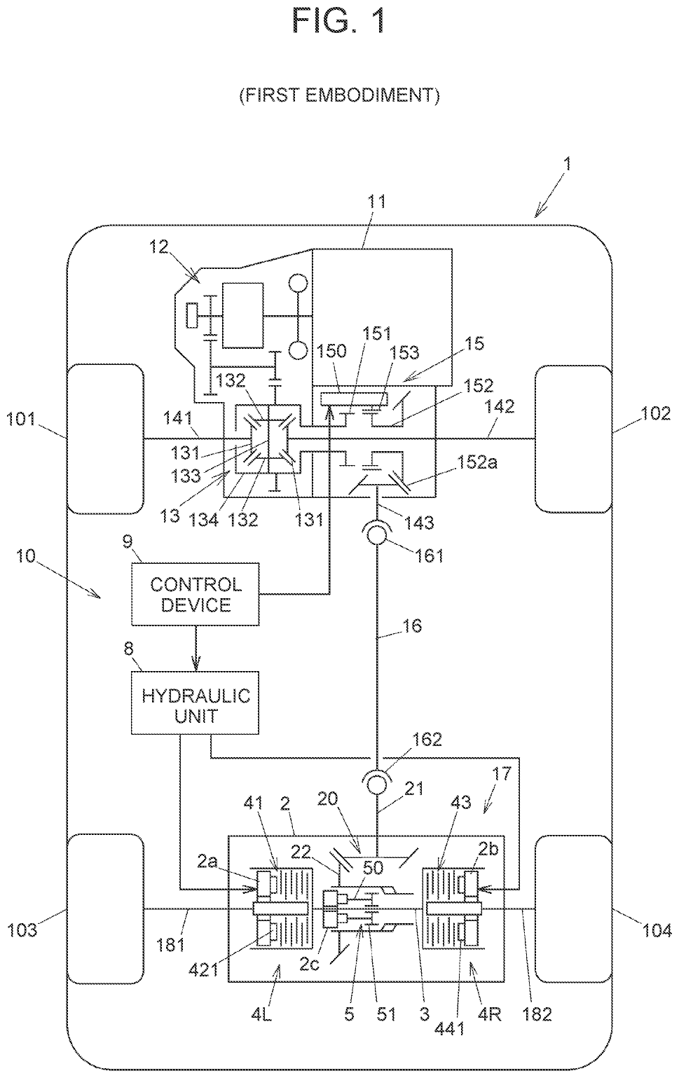

A first embodiment of the disclosure will be described with reference to FIG. 1 to FIG. 5. Embodiments described below will be shown as specific examples. The technical scope of the disclosure is not limited to the embodiments described below.

FIG. 1 is a configuration diagram schematically showing an example of the configuration of a four-wheel-drive vehicle provided with a clutch device according to a first embodiment of the disclosure.

A four-wheel-drive vehicle 1 includes left and right front wheels 101, 102 as main driving wheels, left and right rear wheels 103, 104 as sub-driving wheels, and an engine 11 as a driving source, and can switch between a four-wheel-drive state in which the driving force of the engine 11 is transmitted to the left and right front wheels 101, 102 and the left and right rear wheels 103, 104, and a two-wheel-drive state in which the driving force of the engine 11 is transmitted to only the left and right front wheels 101, 102.

The four-wheel-drive vehicle 1 further includes a transmission 12 that changes the speed of rotation of the engine 11; a front differential 13 that distributes the driving force to the left and right front wheels 101, 102; front wheel-side driveshafts 141, 142; a driving force interruption mechanism 15 that can interrupt transmission of the driving force toward the left and right rear wheels 103, 104; a propeller shaft 16 that extends in a vehicle front-rear direction and transmits the driving force toward the left and right rear wheels 103, 104; a driving force distribution device 17 including first and second multi-disc clutches 41, 43 and a positive clutch (i.e., a dog clutch) 5; rear wheel-side driveshafts 181, 182; a hydraulic unit 8 that generates oil pressure for operating the driving force distribution device 17; and a control device 9 that controls the hydraulic unit 8. The first and second multi-disc clutches 41, 43 and the positive clutch 5 of the driving force distribution device 17, the hydraulic unit 8, and the control device 9 constitute a clutch device 10 of the disclosure.

The front differential 13 includes a pair of side gears 131 configured to be respectively coupled to the pair of front wheel-side driveshafts 141, 142; a pair of pinion gears 132 configured to mesh with the pair of side gears 131 with gear shafts thereof directed orthogonal to the pair of side gears 131; a pinion shaft 133 that supports the pair of pinion gears 132; and a front differential case 134 that houses these components. The driving force of the engine 11 is transmitted to the front differential case 134, after the speed of the rotation is changed by the transmission 12.

The driving force interruption mechanism 15 includes a first rotating member 151 that rotates integrally with the front differential case 134; a second rotating member 152 that is disposed next to the first rotating member 151 in an axial direction; a sleeve 153 that can couple the first rotating member 151 and the second rotating member 152 together such that the first rotating member 151 and the second rotating member 152 are unable to rotate relatively to each other; and an actuator 150 that is controlled by the control device 9. The sleeve 153 is moved by the actuator 150 between a coupling position in which the sleeve 153 meshes with the first rotating member 151 and the second rotating member 152, and a non-coupling position in which the sleeve 153 meshes with only the second rotating member 152. When the sleeve 153 is in the coupling position, the first rotating member 151 and the second rotating member 152 are coupled together so as to be unable to rotate relatively to each other, and when the sleeve 153 is in the non-coupling position, the first rotating member 151 and the second rotating member 152 can rotate relatively to each other.

The propeller shaft 16 receives the driving force of the engine 11 from the front differential case 134 through the driving force interruption mechanism 15 and transmits the driving force toward the driving force distribution device 17. A pair of universal joints 161, 162 is provided. The universal joints 161, 162 are respectively mounted at both ends of the propeller shaft 16. The universal joint 161 on a vehicle front side couples a front end of the propeller shaft 16 to a pinion gear shaft 143 that meshes with a ring gear part 152a provided in the second rotating member 152 of the driving force interruption mechanism 15. The universal joint 162 on a vehicle rear side couples a rear end of the propeller shaft 16 to a pinion gear shaft 21 of the driving force distribution device 17 to be described below.

Configuration of Driving Force Distribution Device

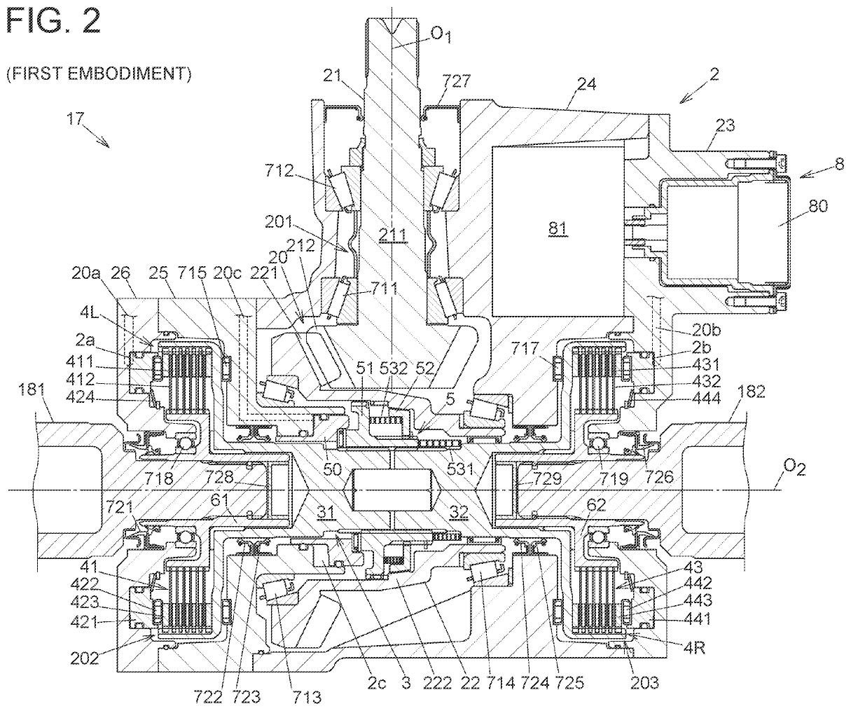

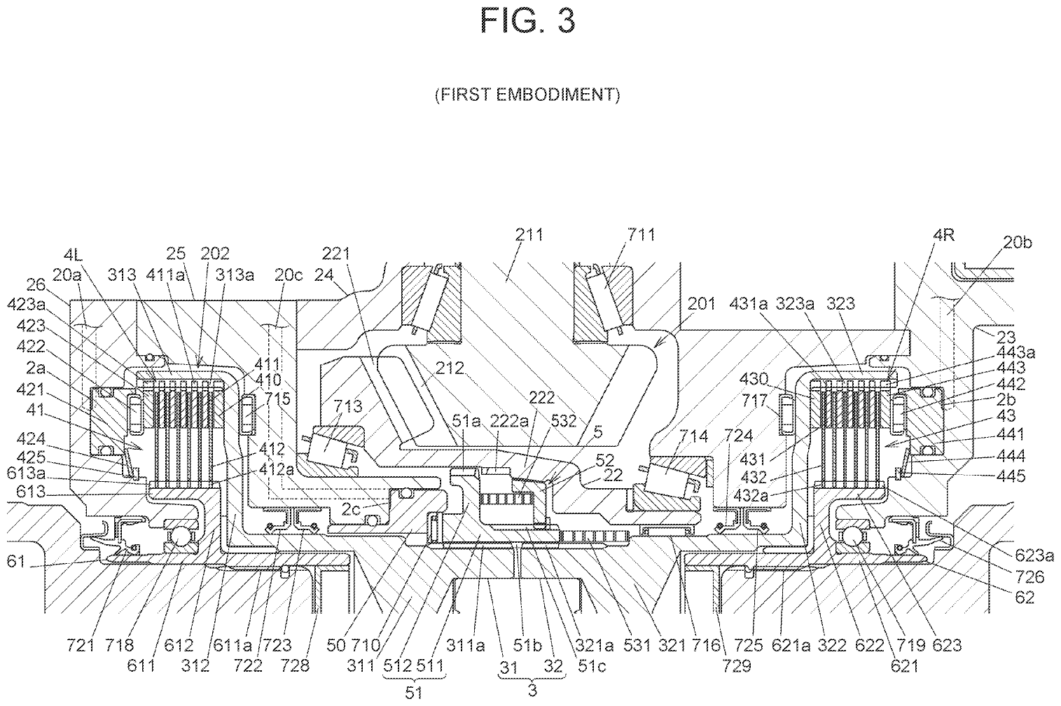

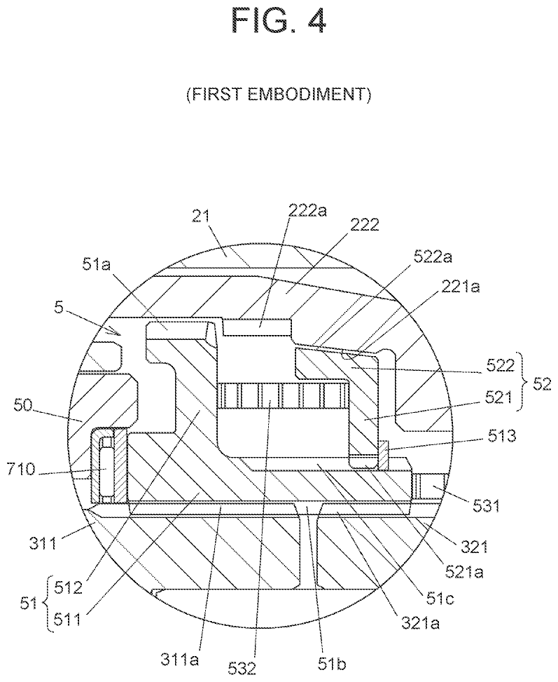

FIG. 2 is an overall sectional view showing an example of the configuration of the driving force distribution device 17. FIG. 3 and FIG. 4 are enlarged views showing a part of FIG. 2 in an enlarged manner.

The driving force distribution device 17 includes an orthogonal gear pair 20 including the pinion gear shaft 21 as an input rotating member and a ring gear member 22 that meshes with the pinion gear shaft 21 with a gear shaft thereof directed orthogonal to the pinion gear shaft 21; a casing 2 including first to fourth case members 23 to 26; an intermediate rotating member 3 that is disposed coaxially with the ring gear member 22 so as to be able to rotate relatively to the ring gear member 22; a first driving force adjustment mechanism 4L including the first multi-disc clutch 41; a second driving force adjustment mechanism 4R including the second multi-disc clutch 43; the positive clutch 5 that interrupts transmission of the driving force (torque) between the pinion gear shaft 21 and the intermediate rotating member 3; and first and second output rotating members 61, 62.

The driving force distribution device 17 outputs the driving force, which has been input from the pinion gear shaft 21, from the first and second output rotating members 61, 62 through the intermediate rotating member 3. In the orthogonal gear pair 20, a rotational axis O₁ of the pinion gear shaft 21 extends in the vehicle front-rear direction, and a rotational axis O₂ of the ring gear member 22 and the intermediate rotating member 3 extends in a vehicle left-right direction. The positive clutch 5 includes a clutch member 51 and a friction member 52, and the clutch member 51 is moved toward the friction member 52 by a pressing force of a piston 50 that generates the pressing force due to hydraulic oil (a hydraulic fluid) supplied from the hydraulic unit 8. In FIG. 1, the casing 2, the orthogonal gear pair 20, the intermediate rotating member 3, the first and second driving force adjustment mechanisms 4L, 4R, the piston 50, and the clutch member 51 are schematically shown.

The casing 2 is formed by fastening the first to fourth case members 23 to 26 together with bolts (not shown). The first case member 23 holds an electric motor 80 of the hydraulic unit 8. The second case member 24 houses a hydraulic circuit 81 of the hydraulic unit 8, the orthogonal gear pair 20, the second driving force adjustment mechanism 4R, and the positive clutch 5. The third case member 25 houses the first driving force adjustment mechanism 4L. The fourth case member 26 closes an opening of the third case member 25. The hydraulic circuit 81 will be described in detail later.

The driving force of the engine 11 is input into the pinion gear shaft 21 through the propeller shaft 16. The pinion gear shaft 21 integrally includes a columnar shaft part 211 that is connected to the universal joint 162 (see FIG. 1) on the vehicle rear side, and a pinion gear part 212 that is provided at one end of the shaft part 211. The shaft part 211 of the pinion gear shaft 21 is supported on the second case member 24 through a pair of tapered roller bearings 711, 712.

The ring gear member 22 includes a ring gear part 221 that meshes with the pinion gear part 212 of the pinion gear shaft 21 with a gear shaft thereof directed orthogonal to the pinion gear part 212, and a cylindrical part 222 that has a central axis directed parallel to the rotational axis O₂ of the ring gear member 22. The ring gear part 221 has a plurality of gear teeth that is formed as a hypoid gear. An inner peripheral surface of the cylindrical part 222 has a meshing portion 222a (see FIG. 3) that is formed by a plurality of spline projections. The ring gear member 22 is rotatably supported by the pair of tapered roller bearings 713, 714.

The intermediate rotating member 3 is disposed coaxially with the ring gear member 22 so as to be able to rotate relatively to the ring gear member 22. In this embodiment, the intermediate rotating member 3 includes a first intermediate shaft member 31 that transmits the driving force, which has been transmitted to the ring gear member 22, to the first driving force adjustment mechanism 4L, and a second intermediate shaft member 32 that transmits the driving force, which has been transmitted to the ring gear member 22, to the second driving force adjustment mechanism 4R.

As shown in FIG. 3, the first intermediate shaft member 31 integrally includes a shaft-shaped shaft part 311 of which one end portion is housed inside the cylindrical part 222 of the ring gear member 22; an annular plate part 312 that projects radially outward from an outer peripheral surface of the shaft part 311; and a cylindrical part 313 that extends in an axial direction parallel to the rotational axis O₂ from a radially outer-side end of the annular plate part 312. An outer peripheral surface of the shaft part 311 is provided with a meshing portion 311a that is formed by a plurality of spline projections. An inner peripheral surface of the cylindrical part 313 is provided with a meshing portion 313a that is formed by a plurality of spline projections.

Similarly, the second intermediate shaft member 32 integrally includes a shaft-shaped shaft part 321 of which one end portion is housed inside the cylindrical part 222 of the ring gear member 22; an annular plate part 322 that projects radially outward from an outer peripheral surface of the shaft part 321; and a cylindrical part 323 that extends in an axial direction parallel to the rotational axis O₂ from a radially outer-side end of the annular plate part 322. An outer peripheral surface of the shaft part 321 is provided with a meshing portion 321a that is formed by a plurality of spline projections. An inner peripheral surface of the cylindrical part 323 is provided with a meshing portion 323a that is formed by a plurality of spline projections. The shaft part 311 of the first intermediate shaft member 31 and the shaft part 321 of the second intermediate shaft member 32 are disposed coaxially along the rotational axis O₂ and face each other in an axial direction inside the cylindrical part 222 of the ring gear member 22.

A thrust roller bearing 715 is disposed between the annular plate part 312 of the first intermediate shaft member 31 and the third case member 25. Further, a cylindrical roller bearing 716 is disposed between the shaft part 321 of the second intermediate shaft member 32 and the cylindrical part 222 of the ring gear member 22, and a thrust roller bearing 717 is disposed between the annular plate part 322 of the second intermediate shaft member 32 and the second case member 24. The piston 50 is disposed inside the cylindrical part 222 of the ring gear member 22 and can move in the direction of the rotational axis O₂ relatively to the ring gear member 22 and the intermediate rotating member 3. The piston 50 has a shape of a cylinder. The shaft part 311 of the first intermediate shaft member 31 is passed through a central part of the piston 50.

The casing 2 has first to third oil passages 20a, 20b, 20c and first to third cylinder chambers 2a, 2b, 2c. The first to third oil passages 20a, 20b, 20c communicate with the first to third cylinder chambers 2a, 2b, 2c, respectively. The hydraulic circuit 81 generates a pressure of hydraulic oil for operating the positive clutch 5 and the first and second driving force adjustment mechanisms 4L, 4R, and supplies the hydraulic oil to the first to third cylinder chambers 2a, 2b, 2c through the first to third oil passages 20a, 20b, 20c. The first to third oil passages 20a, 20b, 20c are formed by holes that are formed in the first to fourth case members 23 to 26 by, for example, a drill.

The first multi-disc clutch 41 is pressed by the pressure of the hydraulic oil supplied to the first cylinder chamber 2a through the first oil passage 20a. The second multi-disc clutch 43 is pressed by the pressure of the hydraulic oil supplied to the second cylinder chamber 2b through the second oil passage 20b. The piston 50 of the positive clutch 5 is moved in the axial direction by the oil pressure of the hydraulic oil supplied to the third cylinder chamber 2c through the third oil passage 20c, and presses the clutch member 51.

The clutch member 51 integrally includes a cylindrical part 511 that is fitted around one end portion of each of the shaft part 311 of the first intermediate shaft member 31 and the shaft part 321 of the second intermediate shaft member 32, and a collar part 512 that projects radially outward from the cylindrical part 511. An outer peripheral surface of the collar part 512 of the clutch member 51 has an outer meshing portion 51a that meshes with the meshing portion 222a formed on the inner peripheral surface of the cylindrical part 222 of the ring gear member 22.

An inner peripheral surface of the cylindrical part 511 of the clutch member 51 has an inner meshing portion 51b that meshes with the meshing portions 311a, 321a respectively formed on the outer peripheral surfaces of the shaft parts 311, 321 of the first and second intermediate shaft members 31, 32. An outer peripheral surface of the cylindrical part 511 of the clutch member 51 has a friction member meshing portion 51c that meshes with the friction member 52 to be described later. The outer meshing portion 51a, the inner meshing portion 51b, and the friction member meshing portion 51c are formed by a plurality of spline projections that each extends in the axial direction.

A first spring member 531 is disposed, in a state of being compressed in the axial direction, between an end surface, in the axial direction, of the cylindrical part 511 of the clutch member 51 and a step surface provided in an outer peripheral surface of the shaft part 321 of the second intermediate shaft member 32. The first spring member 531 is formed by, for example, a coiled wave spring that is formed by spirally winding a flat wire material into a coil while giving it a wavy shape.

The inner meshing portion 51b of the clutch member 51 is always in mesh with the meshing portions 311a, 321a of the first and second intermediate shaft members 31, 32, and the clutch member 51 rotates with the intermediate rotating member 3. The clutch member 51 is moved by the piston 50 in the direction of the rotational axis O₂ relatively to the ring gear member 22 and the intermediate rotating member 3, and is thus moved back and forth between a coupling position in which the outer meshing portion 51a meshes with the meshing portion 222a of the ring gear member 22, and a non-coupling position in which the outer meshing portion 51a does not mesh with the meshing portion 222a of the ring gear member 22. A thrust roller bearing 710 is disposed between the piston 50 and the clutch member 51.

In this embodiment, when the hydraulic oil is supplied to the third cylinder chamber 2c, the clutch member 51 is pressed by the piston 50 and moved to the coupling position, and when the pressure inside the third cylinder chamber 2c is reduced and the pressing force of the piston 50 decreases, the clutch member 51 is moved to the non-coupling position by the urging force of the first spring member 531. In this way, the piston 50 switches between a coupling state in which the intermediate rotating member 3 rotates integrally with the ring gear member 22 and a non-coupling state in which the intermediate rotating member 3 can rotate relatively to the ring gear member 22.

When the clutch member 51 is in the coupling position, the ring gear member 22 and the first and second intermediate shaft members 31, 32 are coupled together by the clutch member 51 so as to be unable to rotate relatively to each other, and the first and second intermediate shaft members 31, 32 rotate integrally with the ring gear member 22. On the other hand, when the clutch member 51 is in the non-coupling position, the ring gear member 22 and the first and second intermediate shaft members 31, 32 can rotate relatively to each other, and torque is not transmitted between the ring gear member 22 and the first and second intermediate shaft members 31, 32.

The friction member 52 generates a frictional force by moving in the direction of the rotational axis O₂ relatively to the ring gear member 22. When the clutch member 51 couples the ring gear member 22 and the first and second intermediate shaft members 31, 32 together, this frictional force reduces the relative rotation speeds of the ring gear member 22 and the first and second intermediate shaft members 31, 32 to allow them to rotate synchronously. This helps the outer meshing portion 51a of the clutch member 51 mesh with the meshing portion 222a of the ring gear member 22.

The friction member 52 has an annular shape and is fitted around the cylindrical part 511 of the clutch member 51. As shown in FIG. 4, the friction member 52 integrally includes an annular plate part 521 and an outer peripheral cylindrical part 522 that extends in the axial direction from a radially outer-side end of the annular plate part 521. An inner peripheral surface of the annular plate part 521 has a meshing portion 521a that is formed by a plurality of spline projections that meshes with the friction member meshing portion 51c of the clutch member 51. Thus configured, the friction member 52 is restrained from rotating relatively to the clutch member 51 while being able to move in the axial direction relatively to the clutch member 51.

Movement of the friction member 52 in a direction away from the collar part 512 of the clutch member 51 is restricted by a retaining ring 513 that is fitted on the outer peripheral surface of the cylindrical part 511 of the clutch member 51. The first spring member 531 urges the clutch member 51 and the friction member 52 in a direction opposite to the pressing direction of the piston 50.

A second spring member 532 is disposed in a compressed state between the annular plate part 521 of the friction member 52 and the collar part 512 of the clutch member 51. The second spring member 532 is formed by, for example, a coiled wave spring. The second spring member 532 elastically transmits the pressing force of the piston 50 to the friction member 52 through the clutch member 51.

An outer peripheral surface of the outer peripheral cylindrical part 522 of the friction member 52 is formed as a tapered friction surface 522a that comes into friction contact with a friction sliding target surface 221a formed in the inner peripheral surface of the cylindrical part 222 of the ring gear member 22. The friction surface 522a and the friction sliding target surface 221a are brought to a state where the friction surface 522a and the friction sliding target surface 221a are parallel to each other and make surface contact with each other, by the pressing force of the piston 50, and generate a frictional force that reduces the relative rotation speeds of the ring gear member 22 and the first and second intermediate shaft members 31, 32. The second spring member 532 elastically brings the friction surface 522a of the friction member 52 into contact with the friction sliding target surface 221a of the ring gear member 22 due to the pressing force of the piston 50. The friction member 52 is pressed along with the clutch member 51 by the piston 50, and a frictional force is generated between the friction member 52 and the friction sliding target surface 221a.

The first output rotating member 61 integrally includes an inner cylindrical part 611 of which an inner peripheral surface has a spline fitting portion 611a to which the driveshaft 107L is coupled so as to be unable to rotate relatively thereto; an annular plate part 612 that projects radially outward from an outer peripheral surface of a substantially central portion, in an axial direction, of the inner cylindrical part 611; and an outer cylindrical part 613 that extends in the axial direction from a radially outer-side end of the annular plate part 612. An outer peripheral surface of the outer cylindrical part 613 has a meshing portion 613a that is formed by a plurality of spline projections extending in the axial direction. The first output rotating member 61 is rotatably supported on the casing 2 through a ball bearing 718 that is disposed between the outer peripheral surface of the inner cylindrical part 611 and an inner surface of the fourth case member 26.

Similarly, the second output rotating member 62 integrally includes an inner cylindrical part 621 of which an inner peripheral surface has a spline fitting portion 621a to which the driveshaft 107R is coupled so as to be unable to rotate relatively thereto; an annular plate part 622 that projects radially outward from an outer peripheral surface of a substantially central portion, in an axial direction, of the inner cylindrical part 621; and an outer cylindrical part 623 that extends in the axial direction from a radially outer-side end of the annular plate part 622. An outer peripheral surface of the outer cylindrical part 623 has a meshing portion 623a that is formed by a plurality of spline projections extending in the axial direction. The second output rotating member 62 is rotatably supported on the casing 2 through a ball bearing 719 that is disposed between the outer peripheral surface of the inner cylindrical part 621 and an inner surface of the first case member 23.

The first driving force adjustment mechanism 4L can adjust the driving force transmitted between the first intermediate shaft member 31 and the first output rotating member 61 in the coupling state in which the intermediate rotating member 3 rotates integrally with the ring gear member 22. Similarly, the second driving force adjustment mechanism 4R can adjust the driving force transmitted between the second intermediate shaft member 32 and the second output rotating member 62 in the coupling state in which the intermediate rotating member 3 rotates integrally with the ring gear member 22.

The first driving force adjustment mechanism 4L includes the first multi-disc clutch 41 including a plurality of outer clutch plates 411 that rotates integrally with the first intermediate shaft member 31, and a plurality of inner clutch plates 412 that rotates integrally with the first output rotating member 61; a piston 421; a thrust roller bearing 422 and a pressing plate 423 that are disposed between the piston 421 and the first multi-disc clutch 41; and a spring member 424 that urges the piston 421 in a direction away from the first multi-disc clutch 41. An outer peripheral end of the pressing plate 423 has a plurality of projections 423a that engages with the meshing portion 313a of the first intermediate shaft member 31. In this embodiment, the spring member 424 is formed by a disc spring. An end portion of the spring member 424 on the opposite side from the piston 421 is locked by a retaining ring 425 that is fitted to the fourth case member 26.

An outer peripheral end portion of each outer clutch plate 411 has a plurality of projections 411a that engages with the meshing portion 313a of the first intermediate shaft member 31. An inner peripheral end portion of each inner clutch plate 412 has a plurality of projections 412a that engages with the meshing portion 613a of the first output rotating member 61. The outer clutch plates 411 can move in the axial direction relatively to the first intermediate shaft member 31, and the inner clutch plates 412 can move in the axial direction relatively to the first output rotating member 61. A receiving plate 410 is disposed between the annular plate part 312 of the first intermediate shaft member 31 and one of the inner clutch plates 412 that is located at a position farthest from the pressing plate 423.

The first multi-disc clutch 41 transmits the driving force from the first intermediate shaft member 31 to the first output rotating member 61 by a frictional force that is generated between the outer clutch plates 411 and the inner clutch plates 412 according to the pressing force applied by the piston 421. The piston 421 is subjected to the oil pressure of the hydraulic oil supplied from the hydraulic circuit 81 to the first cylinder chamber 2a through the first oil passage 20a. When a moving force in the axial direction exerted by this oil pressure becomes larger than the urging force of the spring member 424, the piston 421 moves toward the first multi-disc clutch 41. The first cylinder chamber 2a is formed by an annular groove that is formed in an end surface of the fourth case member 26 on the side of the third case member 25, and the oil pressure of hydraulic oil supplied from the hydraulic circuit 81 to the first cylinder chamber 2a is exerted on the piston 421.

Similarly, the second driving force adjustment mechanism 4R includes the second multi-disc clutch 43 including a plurality of outer clutch plates 431 that rotates integrally with the second intermediate shaft member 32, and a plurality of inner clutch plates 432 that rotates integrally with the second output rotating member 62; a piston 441; a thrust roller bearing 442 and a pressing plate 443 that are disposed between the piston 441 and the second multi-disc clutch 43; and a spring member 444 that urges the piston 441 in a direction away from the second multi-disc clutch 43. An outer peripheral end of the pressing plate 443 has a plurality of projections 443a that engages with the meshing portion 323a of the second intermediate shaft member 32. The spring member 444 is formed by a disc spring, and an end of the spring member 444 on the opposite side from the piston 441 is locked by a retaining ring 445 that is fitted on the first case member 23.

An outer peripheral end portion of each outer clutch plate 431 has a plurality of projections 431a that engages with the meshing portion 323a of the second intermediate shaft member 32. An inner peripheral end of each inner clutch plate 432 has a plurality of projections 432a that engages with the meshing portion 623a of the second output rotating member 62. A receiving plate 430 is disposed between the annular plate part 322 of the second intermediate shaft member 32 and one of the inner clutch plates 432 that is located at a position farthest from the pressing plate 443.

The second multi-disc clutch 43 transmits the driving force from the second intermediate shaft member 32 to the second output rotating member 62 by a frictional force that is generated between the outer clutch plates 431 and the inner clutch plates 432 according to the pressing force applied by the piston 441. The piston 441 is subjected to the oil pressure of the hydraulic oil supplied from the hydraulic circuit 81 to the second cylinder chamber 2b through the second oil passage 20b. When a moving force in the axial direction exerted by this oil pressure becomes larger than the urging force of the spring member 444, the piston 441 moves toward the second multi-disc clutch 43. The second cylinder chamber 2b is formed by an annular groove that is formed in an end surface of the first case member 23 on the side of the second case member 24, and the oil pressure of the hydraulic oil supplied from the hydraulic circuit 81 to the second cylinder chamber 2b is exerted on the piston 441. 100481 An internal space of the casing 2 is divided by seal members 721 to 729 into a first housing part 201 that houses the orthogonal gear pair 20, a second housing part 202 that houses the first driving force adjustment mechanism 4L, and a third housing part 203 that houses the second driving force adjustment mechanism 4R. In the second housing part 202 and the third housing part 203, lubricating oil that lubricates friction sliding of the outer clutch plates 411, 431 and the inner clutch plates 412, 432 and reduces wear is sealed. In the first housing part 201, relatively high-viscosity lubricating oil that lubricates meshing between the ring gear part 221 and the pinion gear part 212 is sealed. The first and second multi-disc clutches 41, 43 are wet friction clutches in which friction sliding of the outer clutch plates 411, 431 and the inner clutch plates 412, 432 is lubricated by lubricating oil.

Operation of Four-wheel-drive Vehicle 1

When the four-wheel-drive vehicle 1 is in the two-wheel-drive state in which the driving force of the engine 11 is transmitted to only the front wheels 101, 102, the control device 9 uncouples the first rotating member 151 and the second rotating member 152 in the driving force interruption mechanism 15, and uncouples the ring gear member 22 and the intermediate rotating member 3 that have been coupled together by the clutch member 51. As a result, the propeller shaft 16, the second rotating member 152 of the driving force interruption mechanism 15, and the orthogonal gear pair 20 stop rotating, even when the four-wheel-drive vehicle 1 is traveling, and thus, power loss due to rotational resistance of these members is reduced and fuel economy performance improves.

To shift from this two-wheel-drive state to the four-wheel-drive state, first, the control device 9 controls the hydraulic unit 8 so as to supply the hydraulic oil to the third oil passage 20c and move the clutch member 51 and the friction member 52 in the axial direction. When rotation of the clutch member 51 and rotation of the ring gear member 22 are synchronized with each other by a frictional force between the friction surface 522a of the friction member 52 and the friction sliding target surface 221a of the ring gear member 22, the outer meshing portion 51a of the clutch member 51 meshes with the meshing portion 222a of the ring gear member 22, and the ring gear member 22 and the first and second intermediate shaft members 31, 32 are coupled together by the clutch member 51 so as to be unable to rotate relatively to each other.

Thereafter, the control device 9 controls the hydraulic unit 8 so as to raise the oil pressure of the hydraulic oil supplied to the first and second cylinder chambers 2a, 2b, and transmits the rotational force of the driveshafts 107L, 107R to the propeller shaft 16 through the first and second driving force adjustment mechanisms 4L, 4R, the first and second intermediate shaft members 31, 32, the clutch member 51, and the orthogonal gear pair 20, and thus rotates the propeller shaft 16. When rotation of the first rotating member 151 and rotation of the second rotating member 152 are synchronized with each other in the driving force interruption mechanism 15, the control device 9 couples, by controlling the actuator 150, the first rotating member 151 and the second rotating member 152 together using the sleeve 153 such that the first rotating member 151 and the second rotating member 152 are unable to rotate relatively to each other. Thus, the driving force of the engine 11 can be transmitted to the rear wheels 103, 104.

Further, the control device 9 distributes a larger driving force to the left wheel 103 than to the right wheel 104 when the vehicle 1 turns right, and distributes a larger driving force to the right wheel 104 than to the left wheel 103 when the vehicle 1 turns left. Thus, understeer during left and right turns is reduced and the vehicle's behavior is stabilized.

Configuration of Hydraulic Unit 8

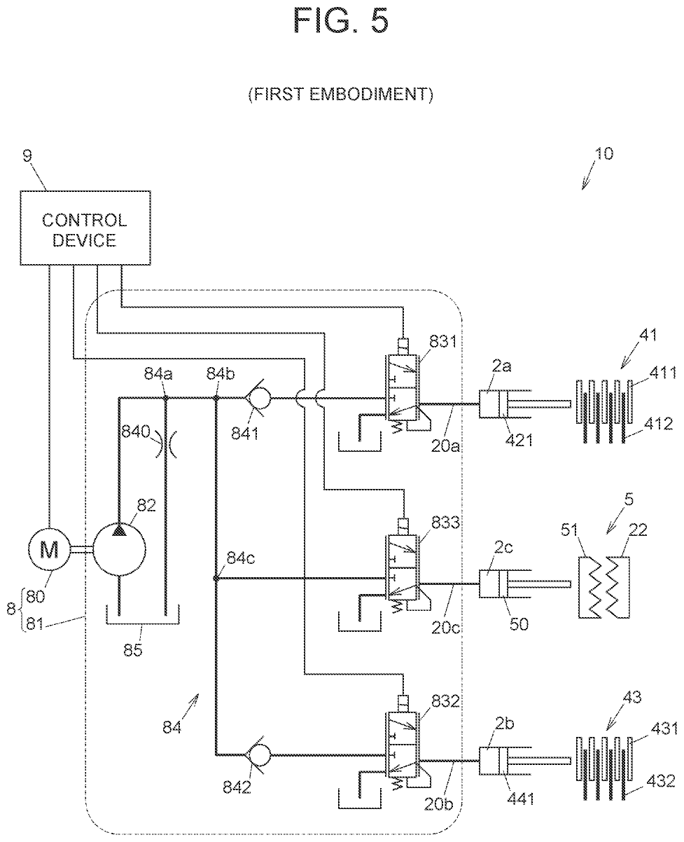

FIG. 5 is a configuration diagram showing one specific example of the configuration of the hydraulic unit 8. The hydraulic unit 8 includes the electric motor 80 and the hydraulic circuit 81, and is controlled by the control device 9 to operate the first and second multi-disc clutches 41, 43 and the positive clutch 5. The hydraulic circuit 81 includes a hydraulic pump 82 that is driven to rotate by the electric motor 80; first to third control valves 831 to 833; an oil passage 84 that distributes the hydraulic oil discharged from the hydraulic pump 82 to the first to third control valves 831 to 833; and a reservoir 85.

The hydraulic pump 82 is, for example, a vane pump or a gear pump, and pumps up the hydraulic oil from the reservoir 85 and discharges the hydraulic oil to the oil passage 84. The oil passage 84 is provided with an orifice 840 that is disposed between a discharge side of the hydraulic pump 82 and the reservoir 85, and first and second check valves 841, 842.

The first to third control valves 831 to 833 are pressure control valves, more specifically, electromagnetic proportional pressure control valves, of which the valve opening degrees change according to the current supplied from the control device 9. The first control valve 831 controls the hydraulic oil that is supplied from the hydraulic pump 82 to the first cylinder chamber 2a. The second control valve 832 controls the hydraulic oil that is supplied from the hydraulic pump 82 to the second cylinder chamber 2b. The third control valve 833 controls the hydraulic oil that is supplied from the hydraulic pump 82 to the third cylinder chamber 2c. Excess hydraulic oil of the hydraulic oil supplied to the first to third control valves 831 to 833, and the hydraulic oil discharged from the first to third cylinder chambers 2a to 2c toward the first to third control valves 831 to 833 each return to the reservoir 85.

The oil passage 84 includes first to third split points 84a, 84b, 84c. The first split point 84a is a split point at which excess of the hydraulic oil discharged from the hydraulic pump 82 is directed toward the orifice 840. The hydraulic oil having passed through the orifice 840 returns to the reservoir 85. The second split point 84b is a split point at which the hydraulic oil from the first split point 84a is split toward the first control valve 831 and toward the third split point 84c. The third split point 84c is a split point at which the hydraulic oil from the second split point 84b is split toward the second control valve 832 and toward the third control valve 833. A valve or the like is not interposed between adjacent points among the first to third split points 84a, 84b, 84c, and the pressures of the hydraulic oil at the first to third split points 84a, 84b, 84c are substantially equal. When implementing the disclosure, where and how to split the path of the oil passage 84 is not limited to the above example and can be changed as necessary according to the structure of the casing 2 etc.

The first check valve 841 is provided between the second split point 84b and the first control valve 831 and blocks a flow of the hydraulic oil in a direction from the first control valve 831 toward the second split point 84b. The second check valve 842 is provided between the third split point 84c and the second control valve 832 and blocks a flow of the hydraulic oil in a direction from the second control valve 832 toward the third split point 84c. No check valve is provided between the third split point 84c and the third control valve 833.

When the positive clutch 5 is switched from a state where transmission of the driving force is interrupted to a state where the driving force can be transmitted, the control device 9 controls the third control valve 833 so as to increase the valve opening degree in the flow passage to the third cylinder chamber 2c and supplies the hydraulic oil to the third cylinder chamber 2c. When the supply passage for supplying the hydraulic oil to the third cylinder chamber 2c is closed, the hydraulic oil is discharged from the third cylinder chamber 2c toward the third control valve 833 as the piston 50 is moved in the axial direction by the urging forces of the first and second spring members 531, 532, and thus, the outer meshing portion 51a of the clutch member 51 and the meshing portion 222a of the ring gear member 22 stop meshing with each other.

When the driving force is transmitted to the left rear wheel 103, the control device 9 controls the first control valve 831 so as to increase the valve opening degree in the flow passage to the first cylinder chamber 2a and supplies the hydraulic oil to the first cylinder chamber 2a. Thus, the piston 421 subjected to the pressure of the hydraulic oil in the first cylinder chamber 2a presses the first multi-disc clutch 41, and a driving force according to the valve opening degree of the first control valve 831 is transmitted to the left rear wheel 103 through the first output rotating member 61 and the driveshaft 181.

When the driving force is transmitted to the right rear wheel 104, the control device 9 controls the second control valve 832 so as to increase the valve opening degree in the flow passage to the second cylinder chamber 2b and supplies the hydraulic oil to the second cylinder chamber 2b. Thus, the piston 441 subjected to the pressure of the hydraulic oil in the second cylinder chamber 2b presses the second multi-disc clutch 43, and a driving force according to the valve opening degree of the second control valve 832 is transmitted to the right rear wheel 104 through the second output rotating member 62 and the driveshaft 182.

The hydraulic circuit 81 is configured as has been described above to distribute the hydraulic oil, which has been discharged from the single hydraulic pump 82, to the first to third cylinder chambers 2a to 2c. Therefore, if the first check valve 841 is not provided and the second split point 84b and the first control valve 831 are directly connected to each other, when the first multi-disc clutch 41 is pressed first and, in this state, the second multi-disc clutch 43 is pressed, increasing the valve opening degree of the second control valve 832 causes the hydraulic oil in the first cylinder chamber 2a to flow backward as the hydraulic oil in the oil passage 84 is drawn into the second cylinder chamber 2b. As a result, the pressing force that the piston 421 exerts on the first multi-disc clutch 41 decreases temporarily.

Further, if the second check valve 842 is not provided and the third split point 84c and the second control valve 832 are directly connected to each other, when the second multi-disc clutch 43 is pressed first and, in this state, the first multi-disc clutch 41 is pressed, increasing the valve opening degree of the first control valve 831 causes the hydraulic oil in the second cylinder chamber 2b to flow backward as the hydraulic oil in the oil passage 84 is drawn into the first cylinder chamber 2a. As a result, the pressing force that the piston 441 exerts on the second multi-disc clutch 43 decreases temporarily.

In this embodiment, the first and second check valves 841, 842 are provided in the oil passage 84 to block such a backflow of the hydraulic oil. Therefore, the driving force transmitted to the left rear wheel 103 through the first multi-disc clutch 41 and the driving force transmitted to the right rear wheel 104 through the second multi-disc clutch 43 are stabilized.

Even when the pressure inside the third cylinder chamber 2c decreases as a result of increasing the valve opening degree of the first control valve 831 or the second control valve 832, and the piston 50 is moved in the axial direction by urging forces of the first and second spring members 531, 532, the state where the positive clutch 5 transmits the driving force is maintained unless the outer meshing portion 51a of the clutch member 51 and the meshing portion 222a of the ring gear member 22 stop meshing with each other. In this embodiment, therefore, no check valve is provided between the third split point 84c and the third control valve 833, which contributes to reducing the size and the cost of the hydraulic circuit 81.

Second Embodiment

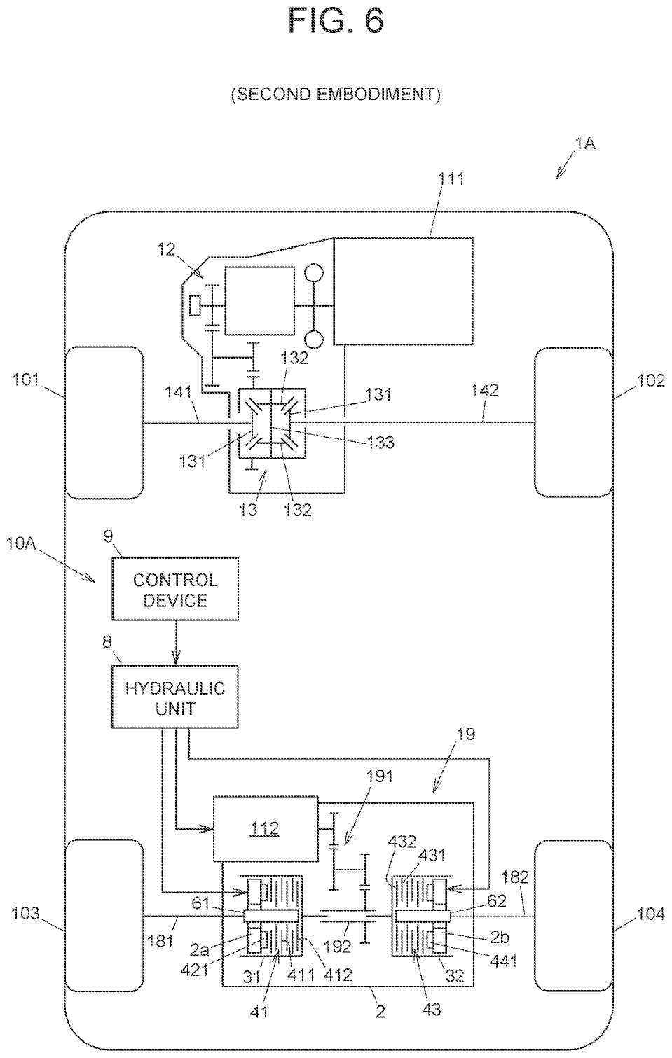

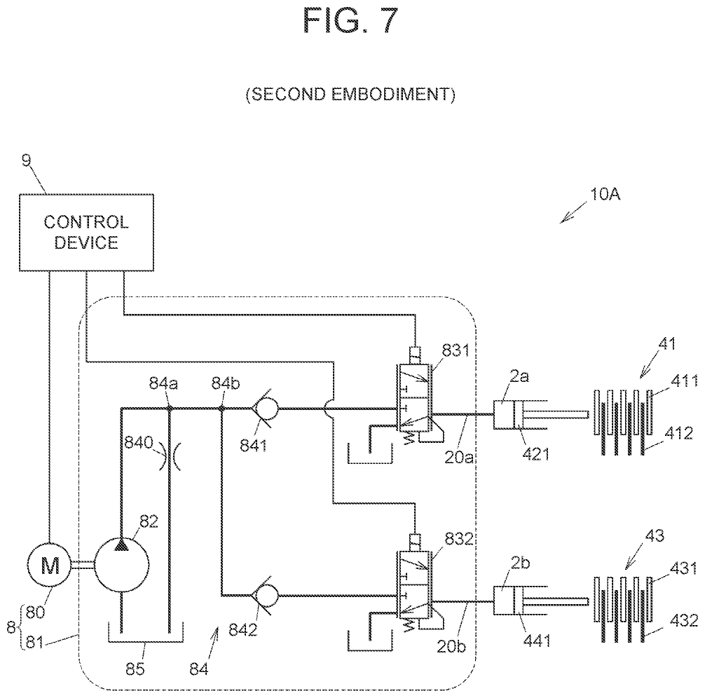

Next, a second embodiment of the disclosure will be described with reference to FIG. 6 and FIG. 7. FIG. 6 is a configuration diagram schematically showing an example of the configuration of a four-wheel-drive vehicle 1A provided with a clutch device 10A according to the second embodiment of the disclosure. FIG. 7 is a configuration diagram showing one specific example of the configuration of a hydraulic unit 8 according to the second embodiment. Members etc. in FIG. 6 and FIG. 7 that are the same as those described in the first embodiment will be denoted by the same reference signs as in FIG. 1 to FIG. 5 and an overlapping description thereof will be omitted.

In the four-wheel-drive vehicle 1A according to this embodiment, the left and right front wheels 101, 102 are driven by an engine 111 as a first driving source, and the left and right rear wheels 103, 104 are driven by an electric motor 112 as a second driving source. The driving force (torque) of the electric motor 112 is distributed to the left and right rear wheels 103, 104 by a driving force distribution device 19.

The driving force distribution device 19 includes the first and second multi-disc clutches 41, 43; a speed reduction mechanism 191 that reduces the speed of rotation output by the electric motor 112; a coupling shaft 192 to which the torque of the electric motor 112 amplified by the speed reduction mechanism 191 is transmitted; the first and second intermediate shaft members 31, 32; and the first and second output rotating members 61, 62. In this embodiment, an interruption mechanism corresponding to the positive clutch 5 in the first embodiment is not provided, but an interruption mechanism may be provided between the electric motor 112 and the coupling shaft 192. Providing such an interruption mechanism can reduce power loss that is caused by rotation of the electric motor 112 and the speed reduction mechanism 191 due to rolling of the left and right rear wheels 103, 104 during traveling in the two-wheel-drive state.

The first and second intermediate shaft members 31, 32 are coupled to the coupling shaft 192 so as to be unable to rotate relatively to the coupling shaft 192. The driveshafts 181, 182 are coupled to the first and second output rotating members 61, 62, respectively. The first multi-disc clutch 41 includes the outer clutch plates 411 that rotate integrally with the first intermediate shaft member 31, and the inner clutch plates 412 that rotate integrally with the first output rotating member 61. The second multi-disc clutch 43 includes the outer clutch plates 431 that rotate integrally with the second intermediate shaft member 32, and the inner clutch plates 432 that rotate integrally with the second output rotating member 62.

The first multi-disc clutch 41 is pressed by the piston 421 that is subjected to the oil pressure of the hydraulic oil supplied from the hydraulic unit 8 to a first cylinder chamber 2a. The second multi-disc clutch 43 is pressed by the piston 441 that is subjected to the oil pressure of the hydraulic oil supplied from the hydraulic unit 8 to a second cylinder chamber 2b.

As shown in FIG. 7, in this embodiment, the oil passage 84 has the first and second split points 84a, 84b. The first check valve 841 is provided between the first control valve 831 and the second split point 84b, and the second check valve 842 is provided between the second control valve 832 and the second split point 84b. Thus, in this embodiment, a plurality of check valves (the first and second check valves 841, 842) is provided so as to respectively correspond to all the control valves (the first and second control valves 831, 832).

When the driving force is transmitted to the left rear wheel 103, the control device 9 controls the first control valve 831 so as to increase the valve opening degree in the flow passage to the first cylinder chamber 2a and supplies the hydraulic oil to the first cylinder chamber 2a. When the driving force is transmitted to the right rear wheel 104, the control device 9 controls the second control valve 832 so as to increase the valve opening degree in the flow passage to the second cylinder chamber 2b and supplies the hydraulic oil to the second cylinder chamber 2b.

Also in the second embodiment, as in the first embodiment, the driving force transmitted to the left rear wheel 103 through the first multi-disc clutch 41 and the driving force transmitted to the right rear wheel 104 through the second multi-disc clutch 43 are stabilized.

While the disclosure has been described above based on the first and second embodiments, these embodiments are not intended to limit the disclosure according to the claims.

Further, the disclosure may be implemented with changes appropriately made to the above embodiments by omitting components or adding or substituting components within the scope of the disclosure. For example, in the above embodiments, the clutch device according to the disclosure is used for a driving force distribution device that distributes the driving force of a driving source to a plurality of wheels in a vehicle. However, without being limited to this example, the clutch device according to the disclosure can be used for various other purposes. In addition, when the clutch device according to the disclosure is used for a driving force distribution device, the configuration of the vehicle is not limited to the configuration illustrated in the above embodiments, and the driving force distribution device using the clutch device according to the disclosure can be applied to vehicles with various configurations.

What is clamed is:

1. A clutch device comprising:
a plurality of clutches;
a plurality of cylinder chambers provided such that the cylinder chambers respectively correspond to the clutches;
a pump configured to discharge a hydraulic fluid;
a plurality of control valves each of which is configured to control the hydraulic fluid supplied from the pump to a corresponding one of the cylinder chambers; and
an oil passage that distributes the hydraulic fluid discharged from the pump, to the control valves, wherein:
the oil passage includes at least one split point at which the hydraulic fluid discharged from the pump splits; and
at least one check valve is provided between the at least one split point and at least one control valve among the control valves, the at least one check valve being configured to block a flow of the hydraulic fluid in a direction from the at least one control valve toward the at least one split point.

2. The clutch device according to claim 1, wherein:
at least one clutch among the clutches is a multi-disc clutch including a plurality of clutch plates; and
the at least one check valve is provided between the at least one split point and the at least one control valve configured to supply the hydraulic fluid to at least one cylinder chamber among the cylinder chambers, each of the at least one cylinder chamber corresponding to the multi-disc clutch.

3. The clutch device according to claim 1, wherein:
the clutches include at least two multi-disc clutches each including a plurality of clutch plates, and a positive clutch configured to transmit torque by meshing;
the at least one check valve is at least two check valves; and
the at least two check valves are provided between the at least one split point and at least two control valves among the control valves, the at least two control valves being configured to supply the hydraulic fluid to at least two cylinder chambers among the cylinder chambers, and the at least two cylinder chambers respectively corresponding to the at least two multi-disc clutches.
